(19) United States
(12) Patent Application Publication
(10) Pub. No.: US 2007/0277037 A1
(43) Pub. Date: Nov. 29, 2007

(54) Software component authentication via encrypted embedded self-signatures

(76) Inventor: Randy Langer, Port Orchard, WA (US)

Correspondence Address: FITCH EVEN TABIN AND FLANNERY, 120 SOUTH LA SALLE STREET, SUITE 1600, CHICAGO, IL, 60603-3406, US

(21) Appl. No.: 10/237,454

(22) Filed: Sep. 6, 2002

Related U.S. Application Data
(60) Provisional application No. 60/317,844, filed on Sep. 6, 2001.

(51) Int. Cl. H04L 9/00

(52) U.S. Cl. 713/176

(57) ABSTRACT

This invention applies to software components that interconnect, as in a frameworks, such that only components “certified” by some designated authority can participate, partly or wholly, in the intended operation of the application. The main emphasis is to limit the set of such software components to those that have been deemed to operate in some specific manner and/or in the scope of some specified set of constraints. The initial application for this invention is to prevent piracy of copyrighted data in multimedia frameworks such as Microsoft DirectShow, but the general invention has much wider applicability. Most authentication systems perform their actions prior to using the software component in question. This invention differs significantly in that it performs validation at runtime, rather than before the component is run. Thus, the validation is always at the most vulnerable point in a component's lifetime so far as counterfeiting is concerned.

This application claims priority to provisional application No. 60/317,844 filed Sep. 6, 2001.

### BACKGROUND OF THE INVENTION

1. Technical Field

This invention applies to software components that interconnect, as in a frameworks, such that only components “certified” by some designated authority can participate, partly or wholly, in the intended operation of the application. The main emphasis is to limit the set of such software components to those that have been deemed to operate in some specific manner and/or in the scope of some specified set of constraints. The initial application for this invention is to prevent piracy of copyrighted data in multimedia frameworks such as Microsoft DirectShow, but the general invention has much wider applicability.

This invention has as its root the concepts of self-signatures (such as a complex hash of a file or executing program image) and “chains of trust,” where each component in a network is validated by the component supplying the data to the component in question. Naturally, the component originating data into such a network would have no predecessor, and thus would not be constrained by a signature or lack thereof, but all other components in the network could be validated using a standard, consistent methodology. The “initial input component” will have to be protected against counterfeiting in some manner other than that described by the current invention.

Although numerous authentication schemes have been developed over the years, the current invention invokes several novel concepts that significantly differentiate it from other techniques in the literature and in current practice.

2. Description of the Prior Art

As just noted, software component authentication is an established field of endeavor. Most solutions in common use involve the use of standard digital signature concepts. While these ideas are good, they can still leave openings for reverse engineering unless elaborate steps are taken to avoid it. This increases the complexity of the overall system, can provide scalability problems, and have other drawbacks that to some degree limit their usefulness in many applications.

The technique employed by the current invention is significantly different from other authentication methods. While it also employs a form of digital signing, it has a completely novel approach to insuring that the signature cannot be subverted by any modification to the corresponding disk file nor by playing tricks with file names across directories (one attack mode that has become popular since most authentication schemes have little protection against this kind of trickery).

### SUMMARY OF THE INVENTION

Most authentication systems perform their actions prior to using the software component in question. This invention differs significantly in that it performs validation at runtime, rather than before the component is run. Thus, the validation is always at the most vulnerable point in a component's lifetime so far as counterfeiting is concerned.

The current invention operates by computing a complex calculation of the software component's executing image, and comparing it against an embedded, encrypted signature in the same executing image or, if necessary, in a “companion” signature file. The encryption uses an asymmetric (“public-key”) algorithm of the sort where the encryption key cannot be deduced from the decryption key. In the preferred embodiment, this is the standard RSA algorithm, although in theory any asymmetric algorithm having the same characteristics of not revealing the encryption key via the decryption key could work as well.

A characteristic of this invention is that the decryption key need not be kept secret; instead, it is the encryption key that must be protected (this is the reverse of how asymmetric encryption algorithms are usually used). Since the calculation of the executing image cannot in practice be kept secret, there is little purpose served by making the decryption key secret either. So the current invention addresses this, as described elsewhere in this Disclosure, by keeping the encryption key secret and implementing a novel protocol to do the authentication.

Some terminology will simplify this discussion: Two components are said to be connected if they have formed some communications channel between them where (possibly valuable) data can be transferred from one component to the other. The source side of the connection is the side supplying the data, while the sink side is the receiver of the data (it is possible for a connection to be bi-directional, in which case this invention treats the connection as two separate connections for the purposes of authentication). The source side authenticates the sink side before sending it any “protected” data (what is meant by “protected” is up to the designers of the overall system, and is out of the scope of this invention). The mechanics of this authentication are covered in the Detailed Description section of this Disclosure.

If the sink side fails authentication, it is up to the source side to decide on the proper course of action. This could entail not sending any data at all to the sink side, sending only “unprotected” data, forcibly terminating the connection, or some other action decided upon by the system's designer. It is an important concept of this invention that the source side of the connection is always in control of the authentication operation; the source side instigates the operation and makes the decision on what to do based on the outcome of the operation; the sink side exercises no influence on this whatsoever (so it cannot take any actions to subvert the security).

Additional aspects, features and advantages of the present invention are included in the following description of exemplary embodiments, which description should be read in conjunction with the accompanying drawings.

### BRIEF DESCRIPTION OF THE DRAWINGS

FIG. 1 shows generating s digital signature from selected sections of an executable file.

FIG. 2 illustrates signing a module.

FIG. 3 illustrates authenticating a module.

FIG. 4 shows a source filter pro-actively authenticating a sink filter before sending sink filter any decryption keys.

FIG. 5 illustrates a chain of trust.

### DESCRIPTION OF EXEMPLARY EMBODIMENTS OF THE INVENTION

The problem of counterfeiting or hacking componental software to make it operate in way unintended by or contrary to the intents or requirements of either the original module provider or the terms of a license under which the module is obligated to operate is addressed by this invention. The core concept is a authentication process in which the “authenticable credentials” of a given software component or other executable module are either embedded in the module's disk image or in a separate signature file in such a manner that:
1. the integrity of the software component or other executable module can be confirmed (i.e., it has not be substituted or modified in a manner that might leave it in a state which could result in the module functioning in a manner inconsistent with the intent of either the original module provider or the terms of a license under which the module is obligated to operate), and
2. the signature is “vouched for” by a trusted signing authority by virtue of the principle that the decryption could have succeeded only because the key(s) used to perform the module signature's encryption is/are believed to be in the sole and exclusive possession of that trusted signing authority.

The software component or other executable module can be partitioned such that the signature (e.g., an SHA-1 hash calculation) can be performed on the executing image of the software component or other executable module when that module is deployed in a manner that can be compared with a similar signature calculated by a legitimate signing authority (which might determine the module's signature either from the module's disk file or from its executing image, depending on the characteristics of the deployment environment, e.g., the operating system). The module signature as determined by the signing authority is encrypted using a key or keys known only to the signing authority (or authorities, depending on how the system's designer wants to partition the signing authority capability). The corresponding decryption key(s) are known to every software implementation that will want to authenticate software components or other executable modules employing the current invention. There is no need for these decryption keys to be kept secret, nor is there any need for the module signatures themselves to be secret. The overall security of this scheme rest on the principle that the encryption keys cannot be inferred or reverse-engineered from the decryption key(s), even if one or more samples of ciphertext (in the form of encrypted module signatures) are available. Only certain encryption algorithms, such as RSA, possess this characteristic, so implementations of the current invention will require constraining the selection of algorithms for encrypting module signatures to those possessing this characteristic. In the preferred embodiment, RSA is used as the encryption algorithm for encrypting and decrypting module signatures.

Signing a module can take any of a number of protocols, decided upon by the system's designer; these include a single sole signing authority, a set of alternate authorities, etc, as described elsewhere in this Disclosure. In a typical scenario, the signing authority (or authorities) are accessed over a network connection (e.g., the Internet), and files representing software components or other executable modules are transmitted to the signing authority via that medium. The signing authority creates the module's signature and either embeds it into the module's disk file or stores it in a separate signature file. In either case, the result of the singing authority's actions are replied back to the individual, organization, etc. making the original request. Once signed, the software component or other executable module can be distributed in the normal manner (this might also entail distributing the signature file, if that option was used for one or more modules being distributed).

When the software component or other executable module is deployed by a user (i.e., someone besides the signing authority), the context of that deployment can authenticate the component or module by re-calculating the module signature, decrypting the reference signature (embedded in the module or from a signature file) and comparing the two to decide on authenticity.

A module signature can comprise more than just a hash of the module's binary (or part of the binary); frequently, additional data such as time stamps, serial and/or revocation IDs, and the like are bundled into a module signature, which is encrypted and decrypted as a unit.

The drawings provided here use the Window PE file format to provide a concrete example of how the invention could be used. The invention is not limited to the PE file format or to Microsoft products; it can be applied as a general concept to virtually any file-based architecture (and possibly to more unusual architectures).

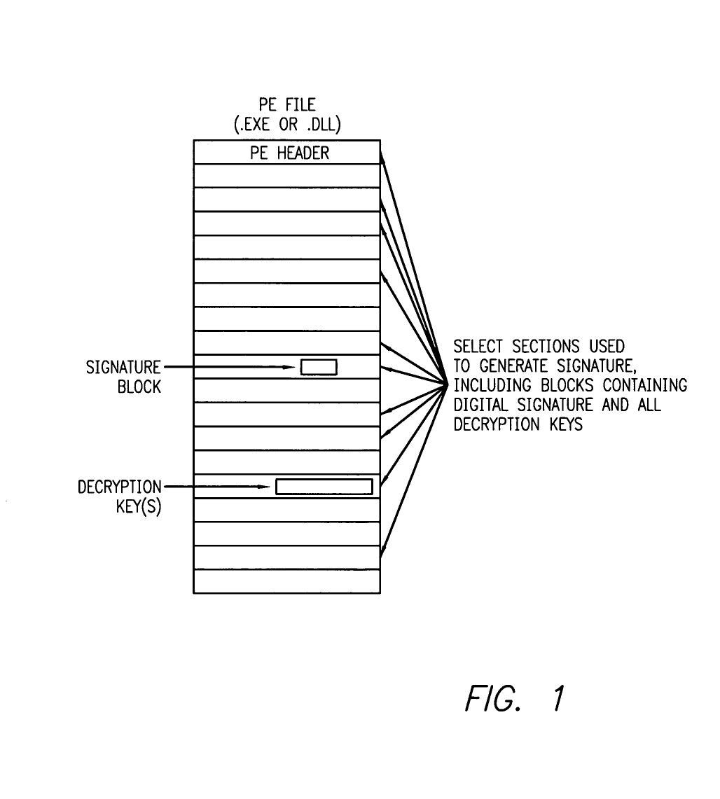

FIG. 1 shows that a file could (but not necessarily must) be broken into sections, only some of which are used to generate the “signature” for the file. This is useful for situations such as the PE file format, where parts of the effective “file image” (represented by the executing image in memory) could differ in content over time. Only relatively “fixed” sections (code, read-only data, etc.) are used for the signature. It is important to note that the part of the image covered by the signature includes both the (possibly encrypted) signature block and all the decryption keys used by this invention. In the preferred embodiment, these selected sections are fed into an SHA-1 hash algorithm, to generate a 160-bit signature.

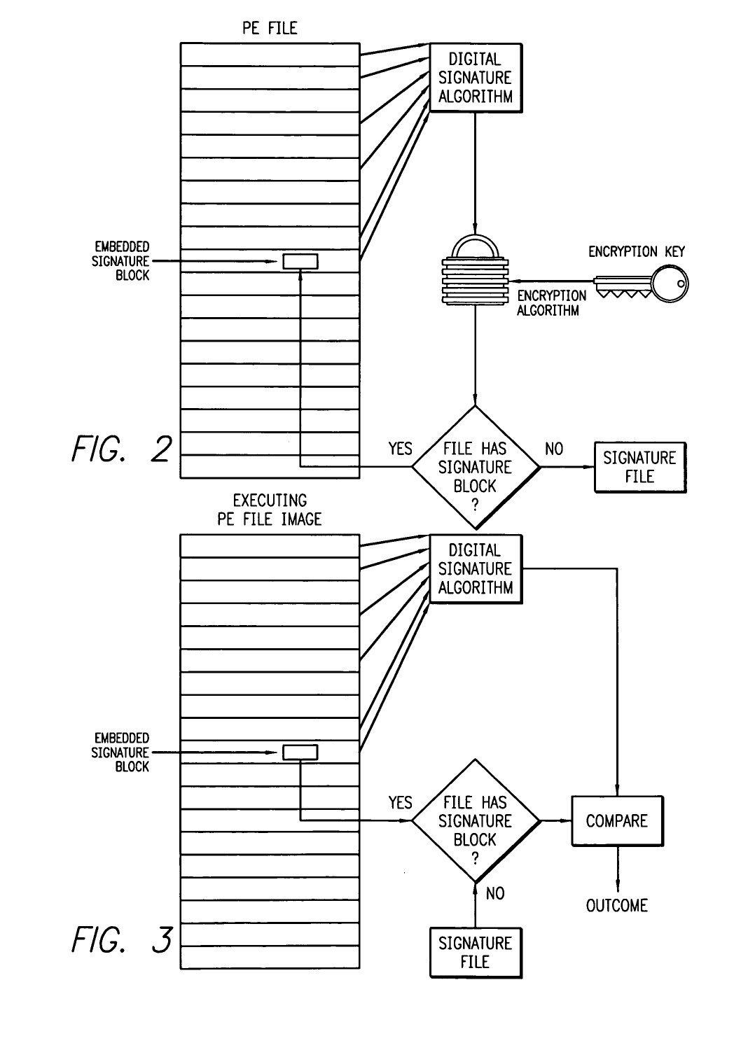

In FIG. 2, the signature of the file is calculated from the selected sections. This is encrypted with a secret key by (for example) an independent signing entity. The encrypted signature is embedded in the executable image itself or in a separate signature file. The signature can be embedded only if the executable file was built such that a special section of the file exists in which to place this signature.

FIG. 3 comes into play when the “signed” executable is run. The signature of the actual executing image is re-calculated, and the software entity doing the authentication also decrypts the signature block either embedded in the executing image or from a separate signature file. Only if the two signatures match will the module being authenticated be fully “enabled” according to the rules as set forth by all parties involved with this instance of the invention.

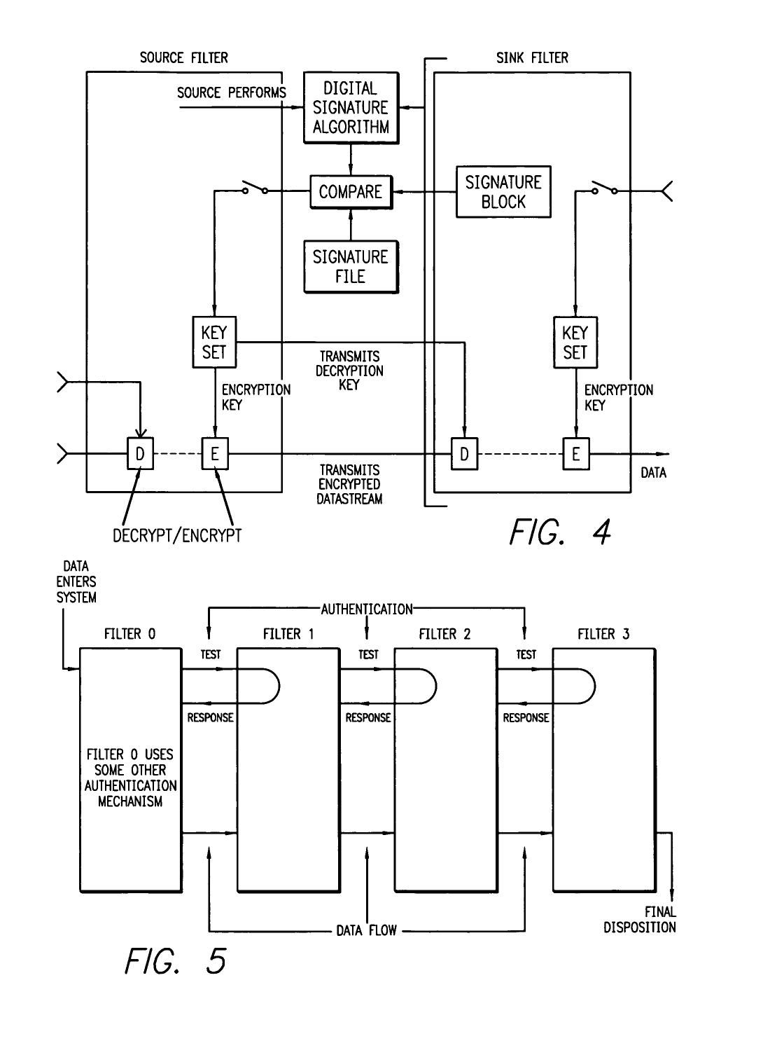

This is further depicted in FIG. 4. When two modules attempt to establish a communications connection, the “source side” authenticates the “sink side”, and only sends the sink side “protected” data if the authentication succeeds. In this particular example, content data is encrypted and sent regardless of authentication; but the decryption keys are only sent if authentication succeeds; this is a valid scenario because the sink side can do nothing with the encrypted content data if it never received the decryption keys.

Further details on authentication and various other aspects of the present invention are described further in the following co-assigned patent applications, all of which are by the same inventor, filed concurrently with the present application, and which are hereby incorporated by reference: a patent application entitled “Secure Protocols for use with Microsoft DirectShow Filters” that claims priority from provisional application No. 60/317,754 filed Sep. 6, 2001; a patent application entitled “Deterring Reverse-Engineering of Software Systems by Randomizing the Siting of Stack-Based Data” that claims priority from provisional application No. 60/317,753 filed Sep. 6, 2001; and a patent application entitled “Asymmetric Encryption to Prevent Fraudulent Replacement of Data” that claims priority from provisional application No. 60/317,751 filed Sep. 6, 2001.

Finally, FIG. 5 demonstrates the highest level view. Each module (filter) validates its successor. Any module in the path that fails authentication logically “breaks” the data chain at that point, preventing data from flowing further, including final disposition.

The fundamental goal of the invention is to provide a secure method whereby a software component can be verified as having been vouched for by a trusted agency. It is assumed as part of the deployment model that no internetworking support can be relied upon being available during the authentication process, so this operation must be completely self-contained. A design goal is to allow new software components to be introduced to a given deployment machine without any alteration to other components on the machine. If needed, it is considered allowable to update “companion” data files on the deployment machine so long as anything that had been running on that machine prior to the introduction of the new component would continue to operate without change (i.e., additions are “purely additive”).

The primary goals to be addressed by this invention can be listed thus:
To devise a method whereby a given software component or other executable module can be reliably checked for any modification that would negatively impact the features/constraints/etc. that the use of this invention was intended to protect. This does not necessarily mean testing the entire module, if it is determined that a specific fraction of the entire module can determine the validity of the entire module. A digital signature of the software component or other executable module is an indicated mechanism to address this goal; the term “digital signature” will be used from this point on to describe this check of a software component's integrity from post-signing modification. In the preferred embodiment, this digital signature is implemented as the SHA-1 hash of part or all of the module's load image, either as a disk file or as an executing image.
To embed the signature into the software component in such a fashion that it can be ascertained with a high level of confidence that the signature was in fact embedded by a trusted entity, which for the purposes of discussion will be called the “signing authority.” A given use of the invention may designate a single signing authority, several co-equal authorities, or even a “chain of authorities,” where a given software component must be authenticated by several authorities, either in some specific sequence or in any convenient sequence.
To allow components at runtime to verify the signature of a component it is considering a connection with, such that both the non-modification and the signing by a valid signing authority can be determined with a high level of confidence.
To ensure that no component's signature is in any way dependent on any other component, so that each component can be added to an appropriate network (such as an applications frameworks) without requiring the co-existence of any other specific component (or set of components). What this means in actuality is that each software component's signature is specific to that component and nothing else.
   The specifics of how the current invention achieves these goals is understood to be highly dependent on the general deployment environment (e.g., the operating system and executable file structure), so the current invention focuses on concepts rather than a given environment's specifics. By way of concrete example, the use of this invention under 32-bit Microsoft Windows using the PE file format will be presented, but it must be understood that the invention is not specific to either Windows or the PE format.

In the Windows/PE implementation, segments of the executable file (which could also be a dynamic link library) are evaluated with the SHA-1 hash as defined by the National Security Agency of the United States Government. Not the entire file is used for this computation; for practical reasons, only certain sections (plus the PE header itself) is used. A characteristic of the PE file format is that the same SHA-1 calculation can with some extra work be applied to the executing image and obtain the same results as was generated for the disk file of that executing image. For deployment environments where this is not true, the signing authority may have no option but to execute the software component in order to generate the correct signature data. In any case, it is a fundamental concept of the current invention that the digital signature of a component be verified while the component is executing, regardless of how the signature was generated.

In the expected use of the current invention, a software component is signed by a trusted entity, and then subsequently authenticated and verified (that it was in fact signed by a trusted entity) when it is actually used. The exact condition upon which this authentication is invoked is up to the system's designer, but it typically occurs when the software component in question is going to be on the receiving end of an inter-component connection (i.e., when the software component in question is going to be a connection sink, to use terminology defined earlier in this Disclosure). The authentication in this case would be invoked by the other side (the source side) of the connection. Note that a given software component is never expected to authenticate itself; it is always some other executing software entity (typically, the source side of a connection) that performs the authentication.

The signing process involves the signing authority calculating the digital signature (in the preferred embodiment, this is the SHA-1 hash of specific sections of the PE file) of the software component, either from its disk file or (if necessary) from a “locally executing” image of the software component. This signature is represented by a byte buffer of some characteristic length (e.g., for SHA-1, 20 bytes). The signing authority then encrypts this signature (and optionally other useful data) using one key (or set of keys) of an asymmetric encryption algorithm (in the preferred embodiment, RSA). This encryption key(s) is/are known only to the signing authority, and is kept highly secret. Once encrypted, the signature is then embedded into the software component's disk file in such a manner that it doesn't otherwise impact the usefulness of the software component when it is subsequently run, and is easy to locate in the software component's executing image when the component is subsequently authenticated. The disk file of the software component may then be distributed.

When the software component is later used in an application where it is necessary to authenticate it, the software performing the authentication re-calculates the digital signature (e.g., the SHA-1 hash) of the executing image (not the disk file), and uses the built-in decryption key(s) to decrypt the embedded signature placed there by the signing authority. It can then compare the re-calculated signature with the data from the decryption for a match, and take appropriate action on the outcome of that test.

The current invention is not limited to “top level” components in specific network facility. Any dependent modules (e.g., dynamic link libraries) could also be included in the authentication facility. In these cases, it might not be practical to embed the signature, encrypted or otherwise, in the disk file of the module. Thus, the current invention also makes provisions for signatures to be alternatively loaded out of a separate signature file. It is an option for the system developer whether to use a separate signature file for each such module or combine multiple signatures into one or a few “aggregated” signature files. In any case, the signature is encrypted in the same manner as it would be if it was embedded into the software component's own disk file. The authentication mechanism must be able to determine that a given module does not have an embedded signature, and know how to find the proper “external” signature file and fetch the (encrypted) signature out of that file.

In a typical use of the current invention, each software component in a network of such components will incorporate the features of the current invention. In this case, each component is authenticated by the component(s) that source data to the component in question. Each such component will thus have an (encrypted) digital signature to provide its sourcing component(s) and the mechanism to authenticate the signature(s) of all its sinking component(s). To improve security, the decryption key(s) used to decrypt embedded digital signatures in sinking components is part of the file covered by that component's own signature, which means that it is part of the verification process when that filter is authenticated by its own sourcing filters. Thus, any attempt to modify the built-in decryption key(s) (to allow the filter in question to authenticate a component signed by an entity other than a legitimate signing authority) will cause the so-modified filter to fail authentication by its sourcing components, thus maintaining the “chain of trust” model that is a feature of the current invention.

Although the invention has been described with respect to various exemplary embodiments, it will be understood that the invention is entitled to protection within the full scope of the appended claims.

1. (canceled)

2. A method of using a file and an encrypted signature of the filed, said filed having a decryption key of an asymmetric key pair embedded in said file, wherein the encrypted signature includes the decryption key and was produced by encrypting a first signature of the file using a first computer system and using an encryption key of the asymmetric key pair, the method comprising:
decrypting the encrypted signature using a second computer system and using the decryption key to produce a decrypted signature;
computing a second signature of the file using the second computer system; and
comparing the second signature with the decrypted signature.

3. The method of claim 2 wherein the encrypted signature is embedded in the file.

4. The method of claim 2 wherein the file is a first file, and wherein the encrypted signature is at least a portion of a signature file that is separate from the first file.

5. The method of claim 2 wherein the encrypted signature was produced by using the RSA algorithm.

6. The method of claim 2 wherein the first signature of the file was produced by using the SHA-1 algorithm.

7. The method of claim 2 wherein the file is art executable file, the method further comprising:
executing the executable file using the second computer system;
wherein the step of decrypting the encrypted signature includes decrypting the encrypted signature while the executable file is executing.

8. The method of claim 7 wherein the encrypted signature is embedded in the file.

9. The method of claim 7 wherein the file is a first file, and wherein the encrypted signature is at least a portion of a signature file that is separate from the first file.

10. The method of claim 7 wherein the file is in the PE file format.

11. A method of providing a file for use by a first computer system adapted to decrypt an encrypted signature of the file using a decryption key of an asymmetric key pair to produce a decrypted signature, said first computer system being further adapted to compute a second signature of the file, and to compare the second signature with the decrypted signature, said method comprising:
embedding the decryption key in the file;
computing a first signature of the file using a second computer system, wherein the first signature includes the decryption key; and
encrypting the first signature using the second computer system and using an encryption key of the asymmetric key pair to produce the encrypted signature.

12. The method of claim 11 further comprising embedding the encrypted signature in the file.

13. The method of claim 11 wherein the file is a first filed, the method further comprising providing a signature file comprised of the encrypted signature wherein said signature file is separate from the first file.

14. The method of claim 11 wherein the file is a first file, the method further comprising:
determining whether the first file has a signature block portion;
embedding the encrypted signature in the first file if the first file has a signature block portion; and
providing a signature file comprised of the encrypted signature if the first file does not have a signature block portion, wherein said signature file is separate from the first file.

15. The method of claim 11 wherein the step of encrypting the first signature further comprises encrypting the signature using the RSA algorithm.

16. The method of claim 11 wherein the step of computing the first signature of the file further comprises computing the first signature of the file using the SHA-1 algorithm.

17. The method of claim 11 wherein the file is an executable file, and wherein the first computer system is further adapted to execute the executable file and to decrypt the encrypted signature while the executable file is executing.

18. The method of claim 17 further comprising embedding the encrypted signature in the file.

19. The method of claim 17 wherein the file is a first file, the method further comprising providing a signature file comprised of the encrypted signature wherein said signature file is separate from the first file.

20. The method of claim 17 wherein the file is in the PE file format.

21. A method of using a file, comprising:
embedding a decryption key of an asymmetric key pair in the file;
computing a first signature of the file using a first computer system, wherein the first signature includes the decryption key;
encrypting the first signature using an encryption key of the asymmetric key pair to produce an encrypted signature;
decrypting the encrypted signature using the decryption key and using a second computer system to produce a decrypted signature;
computing a second signature of the file using the second computer system; and
comparing the second signature with the decrypted signature.

22. The method of claim 21 wherein the file is an executable file, the method further comprising:
executing the executable file using the second computer system;
wherein the step of decrypting the encrypted signature includes decrypting the encrypted signature while the executable file is executing.

23. The method of claim 21 further comprising embedding the encrypted signature in the file.

24. The method of claim 21 wherein the file is a first file, the method further comprising providing a signature file comprised of the encrypted signature wherein said signature file is separate from the first file.

25. The method of claim 21 wherein the file is a first file, the method further comprising:
determining whether the first file has a signature block portion;
embedding the encrypted signature in the first file if the first file has a signature block portion; and
providing a signature file comprised of the encrypted signature if the first file does not have a signature block portion, wherein said signature file is separate from the first file.

26. A method of using an executable file comprising:
embedding a decryption key of an asymmetric key pair in the executable file;
computing a first signature of the executable file using a first computer system, wherein the first signature includes the decryption key;
encrypting the first signature using an encryption key of the asymmetric key pair to produce an encrypted signature:
determining whether the executable file has a signature block portion;
embedding the encrypted signature in the executable file if the executable file has a signature block portion;
providing a signature file comprised of the encrypted signature if the executable file does not have a signature block portion;
executing the executable file using a second computer system;
decrypting the embedded encrypted signature using the decryption key while the executable file is executing to produce a decrypted signature;
computing a second signature of the executable file using the second computer system; and
comparing the second signature with the decrypted signature.

27. A method of authentication, comprising:
executing a first module to perform the steps comprising:
computing a first signature of a second module while the second module is executing to produce a first computed signature;
retrieving a first decryption key of a first asymmetric key pair;
retrieving a first encrypted signature, wherein said first encrypted signature was encrypted using a first encryption key of the first asymmetric key pair;
decrypting the first encrypted signature using the first decryption key to produce a first decrypted signature; and
comparing the first computed signature with the first decrypted signature.

28. (canceled)

29. The method of claim 27 wherein the second module is in the PE file format.

30. The method of claim 27, further comprising:
transmitting a second decryption key from the first module to the second module if the first computed signature corresponds to the first decrypted signature; and
transmitting a first set of encrypted data from the first module to the second module, said first set of encrypted data being adapted for decryption using the second decryption key.

31. The method of claim 27, further comprising:
transmitting a first set of data from the first module to the second module if the first computed signature corresponds to the first decrypted signature, wherein the first set of data is encrypted; and
transmitting a second set of data from the first module to the second module if the first computed signature does not correspond to the first decrypted signature, wherein the second set of data is unencrypted.

32. The method of claim 27 wherein the first module is adapted to transmit a first set of data to the second module via a communications channel, the method further comprising:
closing the communications channel if the first computed signature does not correspond to the first decrypted signature.

33. The method of claim 27 wherein the first decryption key is embedded in the second module and wherein the first encrypted signature was encrypted from an initial signature wherein said initial signature includes the first decryption key.

34. The method of claim 27 wherein the first decryption key is embedded in the second module and wherein the step of retrieving the first decryption key includes retrieving the first decryption key from the second module.

35. The method of claim 27 wherein the first encrypted signature is embedded in the second module and wherein the step of retrieving the first encrypted signature includes retrieving the first encrypted signature from the second module.

36. The method of claim 27 wherein the first encrypted signature is at least a portion of a signature file that is separate from the second module, and wherein the step of retrieving the first encrypted signature includes retrieving the first encrypted signature from the signature file.

37. The method of claim 27 wherein the first encrypted signature was produced by using the RSA algorithm.

38. The method of claim 27 wherein the step of computing the first signature includes computing the first signature using the SHA-1 algorithm.

39. The method of claim 27, further comprising:
executing the second module to perform the stops comprising:
computing a second signature of a third module to produce a second computed signature;
retrieving a second decryption key of a second asymmetric key pair;
retrieving a second encrypted signature wherein said second encrypted signature was encrypted using a second encryption key of the second asymmetric key pair;
decrypting the second encrypted signature using the second decryption key to produce a second decrypted signature; and
comparing the second computed signature with the second decrypted signature.

40. The method of claim 39, further comprising:
transmitting a third decryption key from the second module to the third module if the second computed signature corresponds to the second decrypted signature; and
transmitting a second set of encrypted data from the second module to the third module, said second set of encrypted data being adapted for decryption using the third decryption key.

41. The method of claim 39 wherein the third module is an executable module and wherein the step of computing the second signature further comprises computing the second signature while the third module is executing.

42. The method of claim 39, further comprising:
transmitting a first set of data from the second module to the third module if the second computed signature corresponds to the second decrypted signature, wherein the first set of data is encrypted; and
transmitting a second set of data from the second module to the third module if the second computed signature does not correspond to the second decrypted signature, wherein the second set of data is unencrypted.

43. The method of claim 39 wherein the second module is adapted to transmit a first set of data to the third module via a communications channel, the method further comprising:
closing the communications channel if the second computed signature does not correspond to the second decrypted signature.

44. The method of claim 39 wherein the second decryption key is embedded in the third module and wherein the second encrypted signature was encrypted from an initial signature wherein said initial signature includes the second decryption key.

45. The method of claim 39 wherein the second decryption key is embedded in the third module and wherein the step of retrieving the second decryption key includes retrieving the second decryption key from the third module.

46. The method of claim 39 wherein the second encrypted signature is embedded in the third module and wherein the step of retrieving the second encrypted signature includes retrieving the second encrypted signature from the third module.

47. The method of claim 39 wherein the second encrypted signature is at least a portion of a signature file that is separated from the third module, and wherein the step of retrieving the second encrypted signature includes retrieving the second encrypted signature from the signature file.

48. The method of claim 39 wherein the second encrypted signature was produced by using the RSA algorithm.

49. The method of claim 39 wherein the step of computing the second signature includes computing the second signature using the SHA-1 algorithm.

50. A method of authentication, comprising:
executing a first module to perform the steps comprising:
computing a first signature of a second module while the second module is executing to produce a first computed signature;
retrieving a first decryption key of a first asymmetric key pair;
retrieving a first encrypted signature that was encrypted using a first encryption key of the first asymmetric key pair;
decrypting the first encrypted signature using the first decryption key while the second module is executing to produce a first decrypted signature; and
comparing the first computed signature with the first decrypted signature; and
executing the second module to perform the steps comprising:
computing a second signature of a third module while the third module is executing to produce a second computed signature;
retrieving a second decryption key of a second asymmetric key pair;
retrieving a second encrypted signature that was encrypted using a second encryption key of the second asymmetric key pair;
decrypting the second encrypted signature using the second decryption key while the third module is executing to produce a second decrypted signature; and
comparing the second computed signature with the second decrypted signature.

51. The method of claim 50, further comprising;
transmitting a third decryption key from the first module to the second module if the first computed signature corresponds to the first decrypted signature;
transmitting a first set of encrypted data from the first module to the second module, said first set of encrypted data being adapted for decryption using the third decryption key;
transmitting a fourth decryption key from the second module to the third module if the second computed signature corresponds to the second decrypted signature; and
transmitting a second set of encrypted data from the second module to the third module, said second set of encrypted data being adapted for decryption using the fourth decryption key.

52. The method of claim 50, further comprising:
transmitting a first set of data from the first module to the second module if the first computed signature corresponds to the first decrypted signature, wherein the first set of data is encrypted;
transmitting a second set of data from the first module to the second module if the first computed signature does not correspond to the first decrypted signature, wherein the second set of data is unencrypted,
transmitting a third set of data from the second module to the third module if the second computed signature corresponds to the second decrypted signature, wherein the third set of data is encrypted; and
transmitting a fourth set of data from the second module to the third module if the second computed signature does not correspond to the second decrypted signature, wherein the second set of data is unencrypted.

53. The method of claim 50 wherein the first module is adapted to transmit a first set of data to the second module via a first communications channel, and wherein the second module is adapted to transmit a second set of data to the third module via a second communications channel, the method further comprising:
closing the first communications channel if the first computed signature does not correspond to the first decrypted signature; and
closing the second communications channel if the second computed signature does not correspond to the second decrypted signature.

54. The method of claim 50 wherein the first decryption key is embedded in the second module, wherein the first encrypted signature was encrypted from a first initial signature wherein said first initial signature includes the first decryption key, wherein the second decryption key is embedded in the third module and wherein the second encrypted signature was encrypted from a second initial signature wherein said second initial signature includes the second decryption key.

55. The method of claim 50 wherein the first decryption key is embedded in the second module, wherein the step of retrieving the first decryption key includes retrieving the first decryption key from the second module, wherein the second decryption key is embedded in the third module, and wherein the step of retrieving the second decryption key includes retrieving the second decryption key from the third module.

56. The method of claim 50 wherein the first encrypted signature is embedded in the second module, wherein the step of retrieving the first encrypted signature includes retrieving the first encrypted signature from the second module, wherein the second encrypted signature is embedded in the third module, and wherein the step of retrieving the second encrypted signature includes retrieving the second encrypted signature from the third module.

57. The method of claim 50 wherein the first encrypted signature is at least a portion of a first signature file that is separate from the second module, wherein the step of retrieving the first encrypted signature includes retrieving the first encrypted signature from the first signature file, wherein the second encrypted signature is at least a portion of a second signature file that is separate from the third module, and wherein the step of retrieving the second encrypted signature includes retrieving the second encrypted signature from the second signature file.
